(19) United States
(12) Patent Application Publication
(10) Pub. No.: US 2026/0087385 A1
(43) Pub. Date: Mar. 26, 2026

(54) METHOD FOR GENERATING TRAINING DATA, AND ELECTRONIC DEVICE

(71) Applicant: BEIJING BAIDU NETCOM SCIENCE TECHNOLOGY CO., LTD., Beijing (CN)

(72) Inventors: Le Zhang, Beijing (CN); Yu Shi, Beijing (CN); Jingbo Zhou, Beijing (CN)

(73) Assignee: BEIJING BAIDU NETCOM SCIENCE TECHNOLOGY CO., LTD., Beijing (CN)

(21) Appl. No.: 19/403,504

(22) Filed: Nov. 28, 2025

(30) Foreign Application Priority Data
Sep. 19, 2025 (CN) 202511349742.X

(51) Int. Cl. G06N 5/04; G06F 3/04845

(52) U.S. Cl. CPC G06N 5/04; G06F 3/04845

(57) ABSTRACT

A method for generating training data is performed by an electronic device, including: obtaining interaction data with an application, determining a state transition image based on the interaction data, generating a plurality of pieces of trajectory data based on the state transition image, obtaining reasoning reference information corresponding to the operation data in the trajectory data output by a multimodal model, by inputting the trajectory data into the multimodal model, and generating training data for training an interaction agent model based on the trajectory data and the reasoning reference information corresponding to the operation data in the trajectory data.

### CROSS-REFERENCE TO RELATED APPLICATION

This application is based on and claims priority to Chinese Patent Application Serial No. 202511349742X, filed on Sep. 19, 2025, the entire contents of which are incorporated herein by reference.

### TECHNICAL FIELD

The disclosure relates to the field of computer technology, and in particular to the field of artificial intelligence technology such as large models, deep learning, and intelligent agent, and in particular to a method and an apparatus for generating training data, an electronic device, and a storage medium.

### BACKGROUND

At present, two methods are usually used to obtain data for training agent models: one involves manual annotation, and the other relies on large models generating data using tools based on manually defined trajectories. However, both methods require manual labor, are costly, and inefficient.

### SUMMARY

A method and an apparatus for generating training data, an electronic device, and a storage medium are provided in the disclosure. The specific solution is as follows.

According to an aspect of the disclosure, a method for generating training data is provided. The method includes: obtaining interaction data with an application, in which the interaction data includes a plurality of pieces of operation data, a pre-operation user interface image corresponding to each piece of operation data, and a post-operation user interface image corresponding to each piece of operation data; determining a state transition image based on the interaction data, in which a node in the state transition image is the user interface image, and a connecting edge between every two user interface images is operation data associated with the two user interface images; generating a plurality of pieces of trajectory data based on the state transition image, in which each piece of trajectory data indicates a trajectory image and an operation data sequence corresponding to a task; obtaining reasoning reference information corresponding to the operation data in the trajectory data output by a multimodal model, by inputting the trajectory data into the multimodal model, in which the reasoning reference information describes a reasoning process for the operation data; and generating training data for training an interaction agent model based on the trajectory data and the reasoning reference information corresponding to the operation data in the trajectory data.

According to another aspect of the disclosure, an electronic device is provided. The electronic device includes: at least one processor; and a memory communicatively coupled to the at least one processor and storing instructions executable by the at least one processor; in which when the instructions are executed by the at least one processor, the at least one processor is caused to perform the method provided in the above embodiments.

According to another aspect of the disclosure, a non-transitory computer readable storage medium is provided, which stores computer instructions. The computer instructions are configured to enable a computer to perform the method provided in the above embodiments.

According to another aspect of the disclosure, a computer program product is provided. The computer program product includes a computer program which when executed by a processor to perform steps of the method provided in the above embodiments.

It should be understood that what is described in this section is not intended to identify key or important features of embodiments of the disclosure, nor is it intended to limit the scope of the disclosure. Other features of the disclosure will be readily understood by the following specification.

### BRIEF DESCRIPTION OF THE DRAWINGS

The accompanying figures are used for a better understanding of the disclosure and do not constitute a limitation on the disclosure.

FIG. 1 is a flowchart illustrating a method for generating training data according to an embodiment of the disclosure.

FIG. 2 is a flowchart illustrating a method for generating training data according to another embodiment of the disclosure.

FIG. 3 is a flowchart illustrating a method for generating a trajectory image in the method for generating training data according to another embodiment of the disclosure.

FIG. 4 is a schematic diagram illustrating an example of a generated trajectory image in the method for generating training data according to an embodiment of the disclosure.

FIG. 5 is a flowchart illustrating a method for generating training data according to another embodiment of the disclosure.

FIG. 6 is a flowchart illustrating a method for generating training data according to another embodiment of the disclosure.

FIG. 7 is a block diagram illustrating an apparatus for generating training data according to an embodiment of the disclosure.

FIG. 8 is a block diagram illustrating an electronic device configured to implement a method for generating training data according to an embodiment of the disclosure.

### DETAILED DESCRIPTION

Exemplary embodiments of the disclosure are described hereinafter in conjunction with the accompanying drawings, which include various details of the embodiments of the disclosure in order to aid in understanding, and should be considered exemplary only. Accordingly, one of ordinary skill in the art should recognize that various changes and modifications can be made to the embodiments described herein without departing from the scope and spirit of the disclosure. Similarly, descriptions of well-known features and structures are omitted from the following description for the sake of clarity and brevity.

The embodiments of the disclosure relate to the field of artificial intelligence technology, such as large models, deep learning, and intelligent agent.

Artificial Intelligence (AI) is a new technical science that studies and develops theories, methods, technologies, and application systems for simulating, extending, and expanding human intelligence.

A large model, also called a Foundation Model, undergoes knowledge extraction and learning via billions of language corpora or images, thus resulting in a large model with billions of parameters.

Deep Learning (DL) involves learning internal laws and representation levels of sample data. The information obtained during the learning processes greatly aids the interpretation of data such as text, images, and sound. The ultimate goal of deep learning is to enable machines to possess analytical and learning capabilities like humans, allowing the machines to recognize data such as text, images, and sound.

An intelligent agent refers to an intelligent entity capable of autonomously perceiving the environment, making decisions and taking actions based on goals, and interacting with the environment to achieve specific functions. The intelligent agent perceives changes in the environment (for example, through sensors or data input), makes judgments and decisions based on learned knowledge and algorithms, and thus executes actions to influence the environment or achieve predetermined goals.

It should be noted that intelligent agent may include a mobile agent and a graphical user interface (GUI) agent.

The mobile agent is a type of intelligent agent based on a multimodal large language model. By recognizing and locating visual and textual information in an application interface, the mobile agent may efficiently plan and execute complex tasks within mobile applications, supporting cross-application operations and pure visual solutions, that is, without relying on a user interface (UI) file of the system, and understanding and operating mobile devices through image analysis.

The GUI Agent is a type of intelligent agent driven by a multimodal visual model, capable of automatically reasoning and executing UI interactions, simulating operations of human users, such as clicking, inputting, dragging, reading interface information, etc., to complete tasks assigned by humans.

It should be noted that in the technical solutions of the disclosure, obtaining, storage, use, and processing of the data is in compliance with the provisions of relevant laws and regulations, and does not violate public order and moral.

The following describes the method and apparatus for generating training data, electronic device, and storage medium according to embodiments of the disclosure with reference to the accompanying drawings.

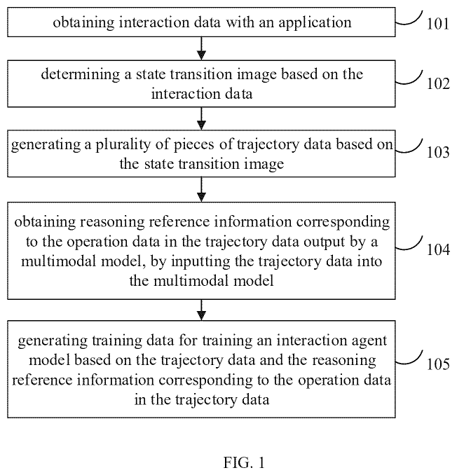

FIG. 1 is a flowchart illustrating a method for generating training data according to an embodiment of the disclosure.

As shown in FIG. 1, the method for generating training data includes the following steps 101 to 105.

At step 101, interaction data with an application is obtained.

The interaction data includes a plurality of pieces of operation data, a pre-operation user interface image corresponding to each piece of operation data, and a post-operation user interface image corresponding to each piece of operation data.

The interaction data may be interaction data between an interaction agent model and the application.

The interaction agent model refers to an intelligent agent with perception, decision-making, and interaction capabilities. The intelligent agent may automatically complete human-computer interaction tasks via image perception capability, semantic understanding capability, and reasoning capability. The specific type and structure of the intelligent agent may be set as needed. For example, the intelligent agent may be a reinforcement learning agent model, a large language model-based agent model, a multimodal agent model, etc., which is not limited in the disclosure.

The interaction agent model may be applied to scenarios such as intelligent terminal automation operation, accessibility assistance, intelligent driving, smart home, etc., which is not limited in the disclosure.

The application that interacts with the interaction agent model may be set as needed. For example, the application may be a commonly used application in daily life, such as an e-commerce application, a meeting application, a communication application, a calendar application, an alarm application, etc., which is not limited in the disclosure.

The operation data may be operation data when interacting with the application. For example, the operation may be, for example, clicking a button or link, sliding a slider, inputting text, etc., which is not limited in the disclosure.

In some possible implementations, when obtaining the interaction data with the application, the method may include: obtaining any user interface image of the application; identifying the any user interface image, and determining a set of operable elements in the any user interface image; and obtaining corresponding operation data and the post-operation user interface image by performing an operation on each operable element in the set of operable elements. Thus, by performing the operation on each operable element in the user interface image, all executable operations in the current user interface image are fully explored, so that diverse and comprehensive interaction data may be constructed. In this case, when building training data for training the interaction agent model based on the interaction data, more interaction scenarios and task objectives may be integrated during the training of the interaction agent model, and thus enable the trained interaction agent model to accurately respond to user instructions and automatically complete tasks in more scenarios in practical applications, which improves the efficiency and experience of human-computer interaction and enhances user convenience.

The set of operable elements may include all operable controls in the user interface image. For example, the set of operable elements may include any controls such as buttons, links, cards, text input boxes, checkboxes, menus, sliders, etc. in the user interface image, which is not limited in the disclosure.

At step 102, a state transition image is determined based on the interaction data.

A node in the state transition image is the user interface image, and a connecting edge between every two user interface images is operation data associated with the two user interface images.

In the disclosure, after obtaining the interaction data with the application, the user interface image in the interaction data may be used as the node, and the operation data associated with every two user interface images may be used as the connecting edge, to construct the state transition image, thus providing a data foundation for subsequently efficiently generating high-quality training data.

At step 103, a plurality of pieces of trajectory data is generated based on the state transition image.

Each piece of trajectory data indicates a trajectory image and an operation data sequence corresponding to a task.

The task may refer to a task supported by the application and an associated task. For example, when the application is an e-commerce application, the task may be product search, order inquiry, logistics, etc., which is not limited in the disclosure.

The trajectory image may include user interface images of all steps for completing the task.

The operation data sequence is a sequence composed of each piece of operation data that completes the task in an operation sequence.

In the disclosure, by generating the plurality of pieces of trajectory data based on the state transition image, the trajectory data may be generated quickly and efficiently based on a graph structure.

In some possible implementations, after generating the plurality of pieces of trajectory data, the method may further include: determining a similarity between any two pieces of trajectory data based on the trajectory images in the pieces of trajectory data; and in a case that the similarity between any two pieces of trajectory data is greater than a similarity threshold, determining that the similarity between the any two pieces of trajectory data is relatively high, that is, the any two pieces of trajectory data are duplicate trajectory data, and thus one of the any two pieces of trajectory data may be deleted from the plurality of pieces of trajectory data. Thus, duplicate trajectories in the trajectory data are removed, redundant data in the trajectory data is reduced, and the quality of the trajectory data is improved.

The similarity threshold is a critical value of similarity used to determine whether any two pieces of trajectory data are duplicate trajectory data, which may be preset as needed, and is not limited in the disclosure.

At step 104, reasoning reference information corresponding to the operation data in the trajectory data output by a multimodal model is obtained by inputting the trajectory data into the multimodal model.

The specific type and architecture of the multimodal model may be preset as needed. For example, the multimodal model may be a two-stream architecture model, an encoder-decoder architecture model, a generative multimodal model, etc., which is not limited in the disclosure.

The reasoning reference information may be text information, which may include analysis of the user interface image before executing the operation data, thinking before selecting the operation data, instructions for selecting the operation data, etc. For example, the reasoning reference information may be a reasoning chain of thought, which is not limited in the disclosure.

In the disclosure, by inputting the trajectory data into the multimodal model, the multimodal model may generate analysis information of the user interface image before executing the operation, thinking information before executing the operation, instruction information for executing the operation, etc., based on changes in the user interface images before and after executing each piece of operation data, and then integrate the information into the reasoning reference information corresponding to the operation data.

In some possible implementations, when generating the reasoning reference information corresponding to the operation data, a task objective corresponding to the trajectory data may also be generated based on the trajectory image and the operation data sequence in the trajectory data, which is not limited in the disclosure.

At step 105, training data for training an interaction agent model is generated based on the trajectory data and the reasoning reference information corresponding to the operation data in the trajectory data.

In the disclosure, when generating the training data for training the interaction agent model based on the trajectory data and the reasoning reference information corresponding to the operation data in the trajectory data, a format of the training data may be: user interface image→reasoning reference information corresponding to the operation data+operation data→user interface image. For example, a format of the training data may be user interface image #1→reasoning reference information corresponding to operation data #1+operation data #1→user interface image #2→reasoning reference information corresponding to operation data #2+operation data #2→user interface image #3→reasoning reference information corresponding to operation data #3+operation data #3→user interface image #4 . . . , which is not limited in the disclosure.

Since the training data obtained in the method for generating training data provided in the disclosure is generated based on fully explored interaction data between the interaction agent model and the application, that is, the interaction data includes a large number of interaction scenarios and tasks, the interaction agent model trained based on the training data may be applied to more interaction scenarios, which improves the diversity and comprehensiveness of human-computer interaction scenarios of the interaction agent model and enhances user experience.

In the embodiments of the disclosure, the interaction data with the application is obtained, the state transition image is determined based on the interaction data, the plurality of pieces of trajectory data is generated based on the state transition image, the reasoning reference information corresponding to the operation data in the trajectory data output by the multimodal model is obtained by inputting the trajectory data into the multimodal model, and the training data for training the interaction agent model is generated based on the trajectory data and the reasoning reference information corresponding to the operation data in the trajectory data. Thus, by analyzing the collected interaction data between the interaction agent model and the application, the trajectory data corresponding to different tasks is generated, which achieves automatic generation of the trajectory data and provides a basis for reducing the cost and time required for training data generation. Further, the reasoning reference information of the operation data in the trajectory data is generated using the multimodal model, thus automatically generating training data based on the trajectory data and the reasoning reference information of the operation data, which improves the efficiency of training data generation.

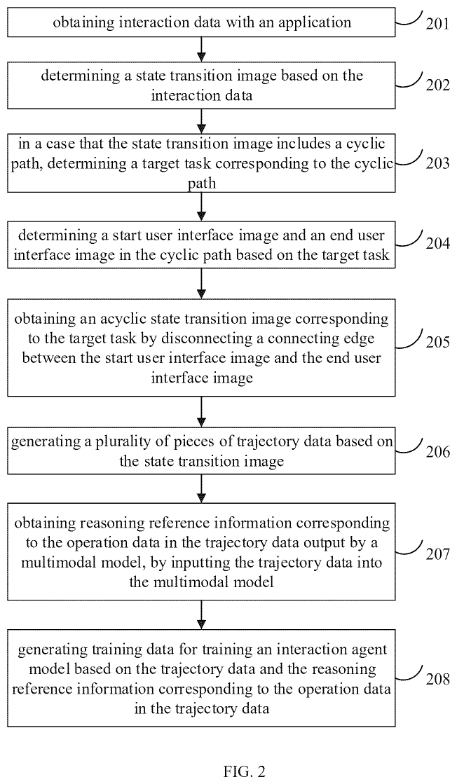

FIG. 2 is a flowchart illustrating a method for generating training data according to another embodiment of the disclosure.

As shown in FIG. 2, the method for generating training data includes the following steps 201 to 208.

At step 201, interaction data with an application is obtained.

The interaction data includes a plurality of pieces of operation data, a pre-operation user interface image corresponding to each piece of operation data, and a post-operation user interface image corresponding to each piece of operation data.

At step 202, a state transition image is determined based on the interaction data.

A node in the state transition image is the user interface image, and a connecting edge between every two user interface images is operation data associated with the two user interface images.

For specific implementations of step 201 to step 205, reference may be made to the detailed descriptions in other embodiments of the disclosure, which will not be repeated here.

At step 203, in a case that the state transition image includes a cyclic path, a target task corresponding to the cyclic path is determined.

The cyclic path in the state transition image refers to a path where the first node and the last node are repeated. That is, a start user interface image and an end user interface image of the cyclic path are the same.

The target task may be determined based on the user interface images and the operation data in the cyclic path. For example, when the cyclic path is “system home screen→click calendar application icon→calendar application home page→click create event button→event creation page→click complete button→event creation completion page→click back button→system home screen”, the target task corresponding to the cyclic path may be determined as creating a calendar event, which is not limited in the disclosure.

In the disclosure, after determining the state transition image, since the state transition image is generated based on all the interaction data, and the interaction data includes a plurality of pieces of operation data, a pre-operation user interface image corresponding to each piece of operation data, and a post-operation user interface image corresponding to each piece of operation data, it is possible that an end user interface image in a certain path is a start user interface image of the path, that is, the state transition image may include a cyclic path. In this case, the target task corresponding to the cyclic path may be determined based on the user interface images and the operation data included in the cyclic path.

At step 204, a start user interface image and an end user interface image in the cyclic path are determined based on the target task.

In the disclosure, after determining the target task of the cyclic path, the start user interface image and the end user interface image in the cyclic path may be determined based on the target task. Taking the above cyclic path as an example, the target task is creating a calendar event, the first operation should be opening the calendar application from the system home screen, and the last operation should be completing the event creation. Thus, the start user interface image of the cyclic path is the interface image before the operation of clicking the calendar application icon, i.e., the system home screen, and the end user interface image is the interface image after the operation of clicking the complete button, i.e., the event creation completion page, which is not limited in the disclosure.

At step 205, an acyclic state transition image corresponding to the target task is obtained by disconnecting a connecting edge between the start user interface image and the end user interface image.

In some possible implementations, the disclosure may use a preset depth-limited search algorithm with cycle pruning to determine whether a cyclic path exists in the state transition image by judging whether a first node and a last node of a path are repeated, and to prune the cyclic path, which is not limited in the disclosure.

In the disclosure, after determining the start user interface image and the end user interface image in the cyclic path, the acyclic state transition image corresponding to the target task is obtained by disconnecting the connecting edge between the start user interface image and the end user interface image. Taking the above cyclic path as an example, the start user interface image is the system home screen, and the end user interface image is the event creation completion page. Thus the connecting edge between the event creation completion page and the system home screen interface may be disconnected, that is, the operation data of “clicking the back button” is removed, which is not limited in the disclosure.

Thus, by pruning the cyclic path in the state transition image, the corresponding acyclic state transition image is obtained, redundant data in the state transition image is reduced, and the quality of the state transition image is improved, which provides a data foundation for obtaining high-quality training data. Further, the interaction agent model may be trained based on the high-quality training data, which improves the performance of the trained interaction agent model and enables the trained interaction agent model to accurately respond to user instructions and complete tasks, thus enhancing user experience.

At step 206, a plurality of pieces of trajectory data is generated based on the state transition image.

Each piece of trajectory data indicates a trajectory image and an operation data sequence corresponding to a task.

In the disclosure, after obtaining the acyclic state transition image by pruning the cyclic path in the state transition image, the plurality of pieces of trajectory data may be generated based on the acyclic state transition images corresponding to all tasks in the state transition image.

At step 207, reasoning reference information corresponding to the operation data in the trajectory data output by a multimodal model is obtained by inputting the trajectory data into the multimodal model.

At step 208, training data for training an interaction agent model is generated based on the trajectory data and the reasoning reference information corresponding to the operation data in the trajectory data.

For specific implementations of step 206 to step 208, reference may be made to the detailed descriptions in other embodiments of the disclosure, which will not be repeated here.

In the embodiments of the disclosure, the interaction data with the application is obtained, the state transition image is determined based on the interaction data, and then in a case that the state transition image includes the cyclic path, the target task corresponding to the cyclic path is determined, and the start user interface image and the end user interface image in the cyclic path are determined based on the target task, and then the acyclic state transition image corresponding to the target task is obtained by disconnecting the connecting edge between the start user interface image and the end user interface image, and the plurality of pieces of trajectory data is generated based on the state transition image, and finally the reasoning reference information corresponding to the operation data in the trajectory data output by the multimodal model is obtained by inputting the trajectory data into the multimodal model, and the training data for training the interaction agent model is generated based on the trajectory data and the reasoning reference information corresponding to the operation data in the trajectory data. Thus, after generating the state transition image based on the interaction data between the interaction agent model and the application, the acyclic state transition image is obtained by pruning the cyclic path in the state transition image, which reduces redundant data in the state transition image and improves the quality of the state transition image, thus providing a data foundation for subsequently generating high-quality training data. Further, trajectory data of different tasks is generated using the state transition image, which reduces noise data in the trajectory data, and the reasoning reference information of the operation data in the trajectory data is generated using the multimodal model, thus automatically generating training data based on the trajectory data and the reasoning reference information of the operation data, which improves the efficiency of training data generation.

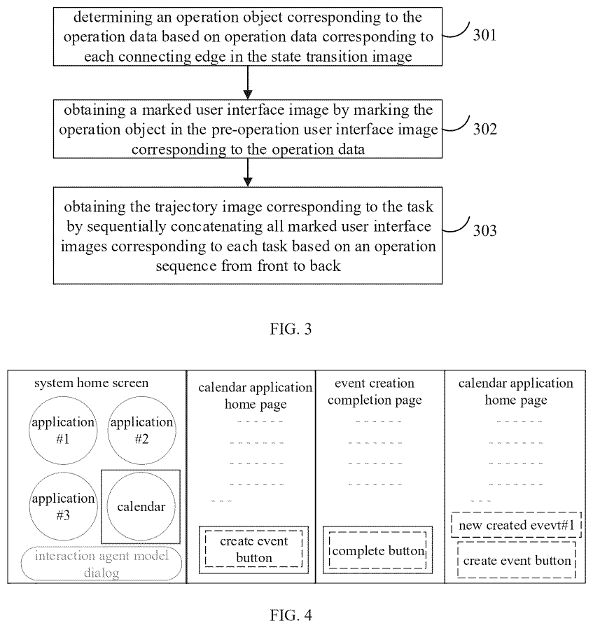

FIG. 3 is a flowchart illustrating a method for generating training data according to another embodiment of the disclosure.

As shown in FIG. 3, the method for generating training data includes the following steps 301 to 303.

At step 301, an operation object corresponding to the operation data is determined based on operation data corresponding to each connecting edge in the state transition image.

The operation object is a corresponding operable element in the user interface image, that is, an operable control.

In the disclosure, after obtaining interaction data with an application and determining a state transition image based on the interaction data, when generating the trajectory image in the trajectory data based on the state transition image, the operation object corresponding to the operation data may first be determined based on the operation data corresponding to each connecting edge in the state transition image. For example, taking the above example as an example, in a case that the operation data is “clicking the calendar application icon”, then the operation object corresponding to the operation data is the calendar application icon on the system home screen; in a case that the operation data is “clicking the create event button”, then the corresponding operation object is the create event button on the calendar application home page, which is not limited in the disclosure.

At step 302, a marked user interface image is obtained by marking the operation object in the pre-operation user interface image corresponding to the operation data.

In the disclosure, after determining the operation object in the pre-operation user interface corresponding to the operation data, the marked user interface image may be obtained by marking via a preset method, thus enabling the subsequent multimodal model to quickly identify the operation object. For example, the operation object may be marked with a solid-line bounding box, etc., which is not limited in the disclosure.

At step 303, the trajectory image corresponding to the task is obtained by sequentially concatenating all marked user interface images corresponding to each task based on an operation sequence from front to back.

In the disclosure, after determining the marked user interface images for each task, the trajectory image corresponding to the task may be obtained by sequentially concatenating all marked user interface images corresponding to each task based on the operation sequence from front to back. For example, the generated trajectory image may be as shown in FIG. 4, which is a schematic diagram illustrating an example of a generated trajectory image in the method for generating training data according to an embodiment of the disclosure. Taking creating a calendar event as an example and using a solid-line bounding box to mark the operation object as an example for illustration, the task includes four marked user interface images. According to the operation sequence from front to back, a system home screen image before clicking the calendar application icon, a calendar application home page before clicking the create event button, an event creation page before clicking the complete button, and an end user interface image, i.e., the event creation completion page, are sequentially concatenated, to obtain the corresponding trajectory image. Each interface image in FIG. 3 is merely an example and is not limited here.

In the embodiments of the disclosure, the operation object corresponding to the operation data is first determined based on the operation data corresponding to each connecting edge in the state transition image; and then the marked user interface image is obtained by marking the operation object in the pre-operation user interface image corresponding to the operation data; and finally the trajectory image corresponding to the task is obtained by sequentially concatenating all marked user interface images corresponding to each task based on the operation sequence from front to back. Thus, by marking the operation object of the operation data in the user interface images of each task and concatenating the marked user interface images based on the operation sequence, the trajectory image corresponding to the task is obtained, which enables the multimodal model to quickly locate the operation object, provides a foundation for the multimodal model to efficiently and accurately generate reasoning reference information for the operation data, and thus improves the efficiency of training data generation.

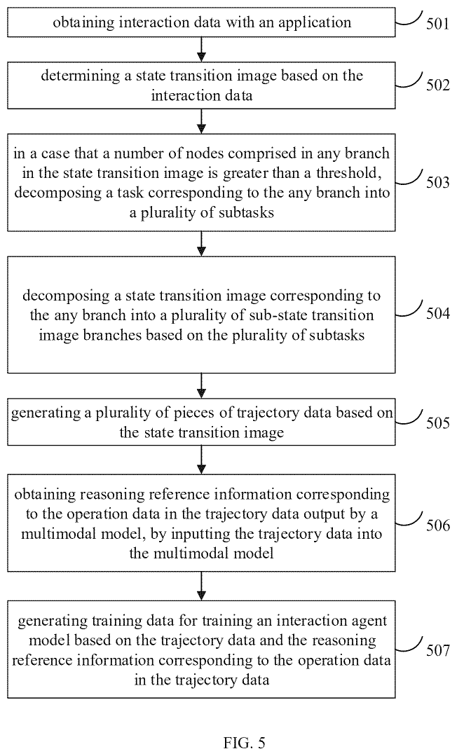

FIG. 5 is a flowchart illustrating a method for generating training data according to another embodiment of the disclosure.

As shown in FIG. 5, the method for generating training data includes the following steps 501 to 507.

At step 501, interaction data with an application is obtained.

The interaction data includes a plurality of pieces of operation data, a pre-operation user interface image corresponding to each piece of operation data, and a post-operation user interface image corresponding to each piece of operation data.

At step 502, a state transition image is determined based on the interaction data.

A node in the state transition image is the user interface image, and a connecting edge between every two user interface images is operation data associated with the two user interface images.

For specific implementations of step 501 to step 502, reference may be made to the detailed descriptions in other embodiments of the disclosure, which will not be repeated here.

At step 503, in a case that a number of nodes included in any branch in the state transition image is greater than a threshold, a task corresponding to the any branch is decomposed into a plurality of subtasks.

The threshold is a critical value of the number of nodes used to determine whether a task corresponding to a branch is a complex task, which may be preset as needed, and is not limited in the disclosure.

In the disclosure, after determining the state transition image based on the interaction data, since the state transition image may include branches with long trajectories and complex tasks, in order to reduce the complexity of the state transition image and ensure clearer logic of the state transition image, the tasks corresponding to such branches may be decomposed.

Thus, in a case that the number of nodes included in any branch in the state transition image is greater than the threshold, it may be determined that the task corresponding to the any branch is a complex task, and thus the task corresponding to the any branch may be decomposed into the plurality of subtasks.

For example, when creating a new calendar event, an alarm reminder is also triggered, then the task includes “creating a new event in the calendar+setting an alarm for a certain day or time”. In this case, the task may be decomposed into two subtasks: one is creating an event, and the other is setting an alarm, which is not limited in the disclosure.

In some possible implementations, when decomposing the task corresponding to the any branch into the plurality of subtasks, the trajectory image and the operation data sequence corresponding to the any branch may be input into the multimodal model, to obtain a plurality of subtasks corresponding to the any branch, and a start user interface image and an end user interface image corresponding to each subtask output by the multimodal model.

In some possible implementations, when decomposing the task corresponding to the any branch into the plurality of subtasks, the plurality of subtasks included in the task corresponding to the any branch may also be determined based on a quantity of entities and/or operation data included in the task corresponding to the any branch.

It should be noted that when determining the plurality of subtasks included in the task corresponding to the any branch based on the quantity of entities and/or operation data included in the task corresponding to the any branch, a language model may be used to parse the task, and then the task is decomposed based on the quantity of entities and/or operation data included in the task, which is not limited in the disclosure.

In the disclosure, when decomposing the task into the corresponding plurality of subtasks, the decomposition may be performed by the multimodal model recognizing the trajectory image and the operation data sequence. Alternatively, the decomposition may be performed by directly using the language model to parse the task, for example, decomposing based on the quantity of entities and/or operation data in the task. Alternatively, the decomposition may be performed simultaneously based on the multimodal model and the quantity of entities and/or operation data included in the task. Thus, the task may be decomposed in a plurality of methods, and the specific decomposition method may be determined as needed, which improves the diversity and flexibility of task decomposition and ensures the accuracy and reliability of the obtained subtasks.

At step 504, a state transition image corresponding to the any branch is decomposed into a plurality of sub-state transition image branches based on the plurality of subtasks.

One sub-state transition image branch corresponds to one subtask.

In the disclosure, after decomposing the task corresponding to the any branch into the plurality of subtasks, the state transition image corresponding to the any branch may be decomposed into the plurality of sub-state transition image branches based on the plurality of subtasks. Thus, by decomposing the branch with the long trajectory and complex task in the state transition image into a plurality of sub-state transition branches, the readability and logical clarity of the state transition image are improved.

For example, taking the above example as an example, based on the two subtasks of creating an event and setting an alarm, the state transition image of the corresponding branch is decomposed into sub-state transition image branches corresponding to the two subtasks respectively, which is not limited in the disclosure.

At step 505, a plurality of pieces of trajectory data is generated based on the state transition image.

Each piece of trajectory data indicates a trajectory image and an operation data sequence corresponding to a task.

In the disclosure, after decomposing the state transition image corresponding to the branch with the long trajectory and complex task in the state transition image into the plurality of sub-state transition image branches, the plurality of pieces of trajectory data may be generated based on all branches included in the state transition image.

At step 506, reasoning reference information corresponding to the operation data in the trajectory data output by a multimodal model is obtained by inputting the trajectory data into the multimodal model.

At step 507, training data for training an interaction agent model is generated based on the trajectory data and the reasoning reference information corresponding to the operation data in the trajectory data.

For specific implementations of step 505 to step 507, reference may be made to the detailed descriptions in other embodiments of the disclosure, which will not be repeated here.

In the embodiments of the disclosure, the interaction data with the application is obtained, the state transition image is determined based on the interaction data, and then in a case that a number of nodes included in any branch in the state transition image is greater than the threshold, the task corresponding to the any branch is decomposed into the plurality of subtasks; the state transition image corresponding to the any branch is decomposed into the plurality of sub-state transition image branches based on the plurality of subtasks; the plurality of pieces of trajectory data is generated based on the state transition image, and then the reasoning reference information corresponding to the operation data in the trajectory data output by the multimodal model is obtained by inputting the trajectory data into the multimodal model, and finally the training data for training the interaction agent model is generated based on the trajectory data and the reasoning reference information corresponding to the operation data in the trajectory data. Thus, after determining the state transition image based on the interaction data between the interaction agent model and the application, the branch with the long trajectory and complex task in the state transition image are decomposed into the plurality of sub-branches, which improves the readability and logical clarity of the state transition image, and thus trajectory data of different tasks may be generated quickly and accurately based on the state transition image, the reasoning reference information of the operation data in the trajectory data may be determined, and the training data is generated based on the trajectory data and the reasoning reference information, which achieves automatic generation of training data for training the interaction agent model and improves the efficiency of training data generation.

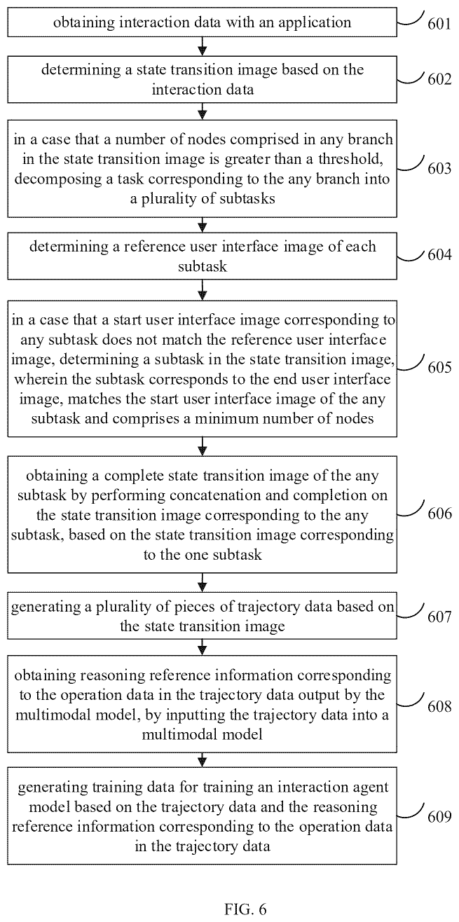

FIG. 6 is a flowchart illustrating a method for generating training data according to another embodiment of the disclosure.

As shown in FIG. 6, the method for generating training data includes the following steps 601 to 609.

At step 601, interaction data with an application is obtained.

The interaction data includes a plurality of pieces of operation data, a pre-operation user interface image corresponding to each piece of operation data, and a post-operation user interface image corresponding to each piece of operation data.

At step 602, a state transition image is determined based on the interaction data.

A node in the state transition image is the user interface image, and a connecting edge between every two user interface images is operation data associated with the two user interface images.

At step 603, in a case that a number of nodes included in any branch in the state transition image is greater than a threshold, a task corresponding to the any branch is decomposed into a plurality of subtasks.

For specific implementations of step 601 to step 603, reference may be made to the detailed descriptions in other embodiments of the disclosure, which will not be repeated here.

At step 604, a reference user interface image of each subtask is determined.

The reference user interface image of each subtask is preset based on the specific subtask, which is not limited in the disclosure.

In the disclosure, after decomposing the task corresponding to the branch into the plurality of subtasks, some operations and user interface images in the subtasks may be missing because the task is decomposed into subtasks, thus causing the obtained decomposed subtasks to be incomplete.

Taking the above task decomposition as an example, the two obtained decomposed subtasks are creating an event and setting an alarm, but a start user interface image of the obtained decomposed subtask of setting an alarm may directly be the time setting interface, and the preceding operations and user interface images are all missing.

Thus, in order to determine whether the decomposed subtasks are complete and to accurately and reliably complete the incomplete subtasks, the reference user interface image of each subtask may first be determined.

At step 605, in a case that a start user interface image corresponding to any subtask does not match the reference user interface image, a subtask in the state transition image is determined, in which the subtask corresponds to the end user interface image, matches the start user interface image of the any subtask and includes a minimum number of nodes.

In the disclosure, in a case that the start user interface image corresponding to any subtask does not match the reference user interface image, it may be determined that the any subtask is incomplete, and the subtask lacks some operations and user interface images. In this case, a subtask in the state transition image, which corresponds to the end user interface image, matches the start user interface image of the any subtask and includes a minimum number of nodes, may be determined, thus ensuring that redundant operations and user interface images are greatly reduced when completing the subtask, and the quality is improved.

At step 606, a complete state transition image of the any subtask is obtained by performing concatenation and completion on the state transition image corresponding to the any subtask, based on the state transition image corresponding to the one subtask.

In the disclosure, by performing concatenation and completion on the state transition image corresponding to the any subtask based on one subtask that matches the start user interface image of the any subtask and includes the minimum number of nodes, the complete state transition image of the any subtask is obtained, which effectively reduces redundant trajectories in the completed subtask, ensures the logical clarity and readability of the completed subtask, and improves the data quality.

At step 607, a plurality of pieces of trajectory data is generated based on the state transition image.

Each piece of trajectory data indicates a trajectory image and an operation data sequence corresponding to a task.

In the disclosure, after completing the state transition image corresponding to the subtask in the state transition image, the plurality of pieces of trajectory data may be generated based on the state transition images corresponding to all tasks included in the state transition image.

At step 608, reasoning reference information corresponding to the operation data in the trajectory data output by a multimodal model is obtained by inputting the trajectory data into the multimodal model.

At step 609, training data for training an interaction agent model is generated based on the trajectory data and the reasoning reference information corresponding to the operation data in the trajectory data.

For specific implementations of step 607 to step 609, reference may be made to the detailed descriptions in other embodiments of the disclosure, which will not be repeated here.

In the embodiments of the disclosure, the interaction data with the application is obtained, the state transition image is determined based on the interaction data, in a case that a number of nodes included in any branch in the state transition image is greater than the threshold, the task corresponding to the any branch is decomposed into the plurality of subtasks; the reference user interface image of each subtask is determined; in a case that the start user interface image corresponding to the any subtask does not match the reference user interface image, the subtask in the state transition image is determined, in which the subtask corresponds to the end user interface image, matches the start user interface image of the any subtask and includes the minimum number of nodes; and the complete state transition image of the any subtask is obtained by performing concatenation and completion on the state transition image corresponding to the any subtask, based on the state transition image corresponding to the one subtask; the plurality of pieces of trajectory data is generated based on the state transition image, the reasoning reference information corresponding to the operation data in the trajectory data output by the multimodal model is obtained by inputting the trajectory data into the multimodal model, and finally the training data for training the interaction agent model is generated based on the trajectory data and the reasoning reference information corresponding to the operation data in the trajectory data. Thus, after generating the state transition image based on the interaction data between the interaction agent model and the application and decomposing the task corresponding to the branch with the long trajectory in the state transition image into the plurality of subtasks, in a case that the start interface image of the subtask does not match a corresponding reference user interface image, it may be determined that the subtask is incomplete. By completing the incomplete subtask based on a subtask in the state transition image that corresponds to the end user interface image, matches the start user interface image of the incomplete subtask and includes a minimum number of nodes, the amount of redundant data in the completed subtask is effectively reduced, and the quality of the state transition image is improved. Further, high-quality trajectory data may be obtained based on the state transition image, and then high-quality reasoning reference information is obtained by processing the high-quality trajectory data using the multimodal model, thus high-quality training data may be automatically generated based on the high-quality trajectory data and the reasoning reference information, which improves the efficiency and accuracy of training data generation, and further enables training a high-performance interaction agent model to enhance the human-computer interaction experience of users.

To implement the above embodiments, an apparatus for generating training data is further provided in the disclosure.

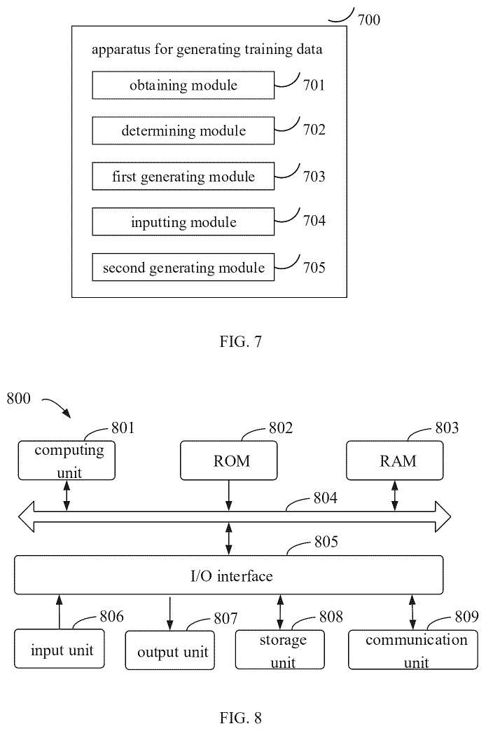

FIG. 7 is a block diagram illustrating an apparatus for generating training data according to an embodiment of the disclosure.

As shown in FIG. 7, the apparatus 700 for generating training data includes an obtaining module 701, a determining module 702, a first generating module 703, an inputting module 704, and a second generating module 705.

The obtaining module 701 is configured to obtain interaction data with an application, in which the interaction data includes a plurality of pieces of operation data, a pre-operation user interface image corresponding to each piece of operation data, and a post-operation user interface image corresponding to each piece of operation data.

The determining module 702 is configured to determine a state transition image based on the interaction data, in which a node in the state transition image is the user interface image, and a connecting edge between every two user interface images is operation data associated with the two user interface images.

The first generating module 703 is configured to generate a plurality of pieces of trajectory data based on the state transition image, in which each piece of trajectory data indicates a trajectory image and an operation data sequence corresponding to a task.

The inputting module 704 is configured to obtain reasoning reference information corresponding to the operation data in the trajectory data output by the multimodal model, by inputting the trajectory data into a multimodal model, in which the reasoning reference information describes a reasoning process for the operation data.

The second generating module 705 is configured to generate training data for training an interaction agent model based on the trajectory data and the reasoning reference information corresponding to the operation data in the trajectory data.

Optionally, the obtaining module 701 is specifically configured to obtain any user interface image of the application; identify the any user interface image, and determining a set of operable elements in the any user interface image; and obtain corresponding operation data and the post-operation user interface image by performing an operation on each operable element in the set of operable elements.

Optionally, the determining module 702 is further configured to, in a case that the state transition image includes a cyclic path, determine a target task corresponding to the cyclic path; determine a start user interface image and an end user interface image in the cyclic path based on the target task; and obtain an acyclic state transition image corresponding to the target task by disconnecting a connecting edge between the start user interface image and the end user interface image.

Optionally, the first generating module 703 is further configured to: determine an operation object corresponding to the operation data based on operation data corresponding to each connecting edge in the state transition image; obtain a marked user interface image by marking the operation object in the pre-operation user interface image corresponding to the operation data; and obtain the trajectory image corresponding to the task by sequentially concatenating all marked user interface images corresponding to each task based on an operation sequence from front to back.

Optionally, the determining module 702 is further configured to: in a case that a number of nodes included in any branch in the state transition image is greater than a threshold, decompose a task corresponding to the any branch into a plurality of subtasks; and decompose a state transition image corresponding to the any branch into a plurality of sub-state transition image branches based on the plurality of subtasks, in which one sub-state transition image branch corresponds to one subtask.

Optionally, the determining module 702 is further configured to: determine a reference user interface image of each subtask; in a case that a start user interface image corresponding to any subtask does not match the reference user interface image, determine a subtask in the state transition image, in which the subtask corresponds to the end user interface image, matches the start user interface image of the any subtask and includes a minimum number of nodes; and obtain a complete state transition image of the any subtask by performing concatenation and completion on the state transition image corresponding to the any subtask, based on the state transition image corresponding to the one subtask.

Optionally, the determining module 702 is further configured to: obtain a plurality of subtasks corresponding to the any branch, and a start user interface image and an end user interface image corresponding to each subtask output by a multimodal model, by inputting the trajectory image and the operation data sequence corresponding to the any branch into the multimodal model; or determine a plurality of subtasks included in the task corresponding to the any branch based on a quantity of entities and/or operation data included in the task corresponding to the any branch.

Optionally, the first generating module 703 is further configured to: determine a similarity between any two pieces of trajectory data based on the trajectory images in the pieces of trajectory data; and in a case that the similarity between any two pieces of trajectory data is greater than a similarity threshold, delete one of the any two pieces of trajectory data from the plurality of pieces of trajectory data.

It should be noted that the explanations and descriptions of the above embodiments of the method for generating training data are also applicable to the apparatus for generating training data in this embodiment, thus will not be repeated here.

In the embodiments of the disclosure, the interaction data with the application is obtained, the state transition image is determined based on the interaction data, the plurality of pieces of trajectory data is generated based on the state transition image, the reasoning reference information corresponding to the operation data in the trajectory data output by the multimodal model is obtained by inputting the trajectory data into the multimodal model, and the training data for training the interaction agent model is generated based on the trajectory data and the reasoning reference information corresponding to the operation data in the trajectory data. Thus, by analyzing the collected interaction data between the interaction agent model and the application, the trajectory data corresponding to different tasks is generated, which achieves automatic generation of the trajectory data and provides a basis for reducing the cost and time required for training data generation. Further, the reasoning reference information of the operation data in the trajectory data is generated using the multimodal model, thus automatically generating training data based on the trajectory data and the reasoning reference information of the operation data, which improves the efficiency of training data generation.

According to embodiments of the disclosure, the disclosure also provides an electronic device, a readable storage medium, and a computer program product.

FIG. 8 is a block diagram illustrating an electronic device according to an embodiment of the disclosure. The electronic device 800 is intended to represent various types of digital computers, such as laptop computers, desktop computers, workstations, personal digital assistants, servers, blade servers, mainframe computers, and other suitable computers. The electronic device may also represent various types of mobile devices, such as personal digital assistants, cellular phones, smart phones, wearable devices, and other similar computing devices. The components shown herein, their connections and relations, and their functions are merely examples, which are not intended to limit the implementations of the disclosure described and/or required here.

As shown in FIG. 8, the device 800 includes a computing unit 801, configured to execute various appropriate actions and processes according to a computer program stored in a read-only memory (ROM) 802 or a computer program loaded from a storage unit 808 to a random access memory (RAM) 803. In the RAM 803, various programs and data required for the device 800 may be stored. The computing unit 801, the ROM 802 and the RAM 803 may be connected with each other by a bus 804. An input/output (I/O) interface 805 is also connected to the bus 804.

The plurality of components in the device 800 are connected to the I/O interface 805, which include: an input unit 806, for example, a keyboard, a mouse; an output unit 807, for example, various types of displays, speakers; a storage unit 808, for example, a magnetic disk, an optical disk; and a communication unit 809, for example, a network card, a modem, a wireless transceiver. The communication unit 809 allows the device 800 to exchange information/data through a computer network such as Internet and/or various types of telecommunication networks with other devices.

The computing unit 801 may be various types of general and/or dedicated processing components with processing and computing abilities. Some examples of a computing unit 801 include but not limited to a central processing unit (CPU), a graphics processing unit (GPU), various dedicated artificial intelligence (AI) computing chips, various computing units on which a machine learning model algorithm is running, a digital signal processor (DSP), and any appropriate processor, controller, microcontroller, etc. The computing unit 801 executes various methods and processes as described above, for example, a method for generating training data. For example, in some embodiments, the method for generating training data may be further implemented as a computer software program, which is tangibly contained in a machine readable medium, such as the storage unit 808. In some embodiments, a part or all of the computer program may be loaded and/or installed on the device 800 via the ROM 802 and/or the communication unit 809. When the computer program is loaded on the RAM 803 and executed by the computing unit 801, one or more steps in the method for generating training data may be performed as described above. Optionally, in other embodiments, the computing unit 801 may be configured to the method for generating training data in other appropriate ways (for example, by virtue of a firmware).

Various implementations of the systems and techniques described above may be implemented by a digital electronic circuit system, an integrated circuit system, field programmable gate arrays (FPGAs), application specific integrated circuits (ASICs), application specific standard products (ASSPs), system on chip (SOCs), load programmable logic devices (CPLDs), computer hardware, firmware, software, and/or a combination thereof. These various embodiments may be implemented in one or more computer programs, the one or more computer programs may be executed and/or interpreted on a programmable system including at least one programmable processor, which may be a dedicated or general programmable processor for receiving data and instructions from the storage system, at least one input device and at least one output device, and transmitting the data and instructions to the storage system, the at least one input device and the at least one output device.

The program code configured to implement the method of the disclosure may be written in any combination of one or more programming languages. These program codes may be provided for the processors or controllers of general-purpose computers, dedicated computers, or other programmable data processing devices, so that the program codes, when executed by the processors or controllers, enable the functions/operations specified in the flowchart and/or block diagram to be implemented. The program code may be executed entirely on the machine, partly executed on the machine, partly executed on the machine and partly executed on the remote machine as an independent software package, or entirely executed on the remote machine or server.

In the context of the disclosure, a machine-readable medium may be a tangible medium that may contain or store a program for use by or in combination with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the above. More specific examples of machine-readable storage media include electrical connections based on one or more wires, portable computer disks, hard disks, RAMs, ROMs, electrically programmable read-only-memory (EPROM), fiber optics, compact disc read-only memories (CD-ROM), optical storage devices, magnetic storage devices, or any suitable combination of the above.

In order to provide interaction with a user, the systems and techniques described herein may be implemented on a computer having a display device (e.g., a cathode ray tube (CRT) or a liquid crystal display (LCD) monitor for displaying information to a user); and a keyboard and pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein can be implemented in a computing system that includes background components (for example, a data server), or a computing system that includes middleware components (for example, an application server), or a computing system that includes front-end components (for example, a user computer with a graphical user interface or a web browser, through which the user can interact with the implementation of the systems and technologies described herein), or include such background components, intermediate computing components, or any combination of front-end components. The components of the system may be interconnected by any form or medium of digital data communication (e.g., a communication network). Examples of communication networks include: a local area network (LAN), a wide area network (WAN), the Internet, and the block-chain network.

The computer system may include a client and a server. The client and server are generally remote from each other and interacting through a communication network. The client-server relation is generated by computer programs running on the respective computers and having a client-server relation with each other. The server may be a cloud server, also called a cloud computing server or cloud host, which is a host product in cloud computing service systems. The cloud server solves the defects of high management difficulty and weak business extensibility existing in traditional physical hosts and virtual private server services (VPS). The server may also be a server in a distributed system, or a server integrated with a block-chain.

According to embodiments of the disclosure, a computer program product is also provided. When instructions in the computer program product are executed by a processor, the method for generating training data provided in the above embodiments of the disclosure is performed.

It should be understood that the various forms of processes shown above can be used to reorder, add or delete steps. For example, the steps described in the disclosure could be performed in parallel, sequentially, or in a different order, as long as the desired result of the technical solution disclosed in the disclosure is achieved, which is not limited herein.

The above specific embodiments do not constitute a limitation on the protection scope of the disclosure. Those skilled in the art should understand that various modifications, combinations, sub-combinations and substitutions can be made according to design requirements and other factors. Any modification, equivalent replacement and improvement made within the spirit and principle of the disclosure shall be included in the protection scope of the disclosure.

What is claimed is:

1. A method for generating training data, comprising:
obtaining interaction data with an application, wherein the interaction data comprises a plurality of pieces of operation data, a pre-operation user interface image corresponding to each piece of operation data, and a post-operation user interface image corresponding to each piece of operation data;
determining a state transition image based on the interaction data, wherein a node in the state transition image is the user interface image, and a connecting edge between every two user interface images is operation data associated with the two user interface images;
generating a plurality of pieces of trajectory data based on the state transition image, wherein each piece of trajectory data indicates a trajectory image and an operation data sequence corresponding to a task;
obtaining reasoning reference information corresponding to the operation data in the trajectory data output by a multimodal model, by inputting the trajectory data into the multimodal model, wherein the reasoning reference information describes a reasoning process for the operation data; and
generating training data for training an interaction agent model based on the trajectory data and the reasoning reference information corresponding to the operation data in the trajectory data.

2. The method according to claim 1, wherein obtaining the interaction data with the application comprises:
obtaining any user interface image of the application;
identifying the any user interface image, and determining a set of operable elements in the any user interface image; and
obtaining corresponding operation data and the post-operation user interface image by performing an operation on each operable element in the set of operable elements.

3. The method according to claim 1, wherein after determining the state transition image, the method further comprises:
in a case that the state transition image comprises a cyclic path, determining a target task corresponding to the cyclic path;
determining a start user interface image and an end user interface image in the cyclic path based on the target task; and
obtaining an acyclic state transition image corresponding to the target task by disconnecting a connecting edge between the start user interface image and the end user interface image.

4. The method according to claim 1, wherein generating the trajectory image comprises:
determining an operation object corresponding to the operation data based on operation data corresponding to each connecting edge in the state transition image;
obtaining a marked user interface image by marking the operation object in the pre-operation user interface image corresponding to the operation data; and
obtaining the trajectory image corresponding to the task by sequentially concatenating all marked user interface images corresponding to each task based on an operation sequence from front to back.

5. The method according to claim 1, wherein after determining the state transition image, the method further comprises:
in a case that a number of nodes comprised in any branch in the state transition image is greater than a threshold, decomposing a task corresponding to the any branch into a plurality of subtasks; and
decomposing a state transition image corresponding to the any branch into a plurality of sub-state transition image branches based on the plurality of subtasks, wherein one sub-state transition image branch corresponds to one subtask.

6. The method according to claim 5, wherein after decomposing the any branch into the plurality of sub-branches, the method further comprises:
determining a reference user interface image of each subtask;
in a case that a start user interface image corresponding to any subtask does not match the reference user interface image, determining a subtask in the state transition image, wherein the subtask corresponds to the end user interface image, matches the start user interface image of the any subtask and comprises a minimum number of nodes; and
obtaining a complete state transition image of the any subtask by performing concatenation and completion on the state transition image corresponding to the any subtask, based on the state transition image corresponding to the one subtask.

7. The method according to claim 5, wherein decomposing the task corresponding to the any branch into the plurality of subtasks comprises at least one of:
obtaining a plurality of subtasks corresponding to the any branch, and a start user interface image and an end user interface image corresponding to each subtask output by a multimodal model, by inputting the trajectory image and the operation data sequence corresponding to the any branch into the multimodal model; or
determining a plurality of subtasks comprised in the task corresponding to the any branch based on a quantity of entities and/or operation data comprised in the task corresponding to the any branch.

8. The method according to claim 1, wherein after generating the plurality of pieces of trajectory data, the method further comprises:
determining a similarity between any two pieces of trajectory data based on the trajectory images in the pieces of trajectory data; and
in a case that the similarity between any two pieces of trajectory data is greater than a similarity threshold, deleting one of the any two pieces of trajectory data from the plurality of pieces of trajectory data.

9. An electronic device, comprising:
at least one processor; and
a memory communicatively coupled to the at least one processor and storing instructions executable by the at least one processor;
wherein when the instructions are executed by the at least one processor, the at least one processor is caused to:
obtain interaction data with an application, wherein the interaction data comprises a plurality of pieces of operation data, a pre-operation user interface image corresponding to each piece of operation data, and a post-operation user interface image corresponding to each piece of operation data;
determine a state transition image based on the interaction data, wherein a node in the state transition image is the user interface image, and a connecting edge between every two user interface images is operation data associated with the two user interface images;
generate a plurality of pieces of trajectory data based on the state transition image, wherein each piece of trajectory data indicates a trajectory image and an operation data sequence corresponding to a task;
obtain reasoning reference information corresponding to the operation data in the trajectory data output by a multimodal model, by inputting the trajectory data into the multimodal model, wherein the reasoning reference information describes a reasoning process for the operation data; and
generate training data for training an interaction agent model based on the trajectory data and the reasoning reference information corresponding to the operation data in the trajectory data.

10. The electronic device according to claim 9, wherein when the instructions are executed by the at least one processor, the at least one processor is caused to:
obtain any user interface image of the application;
identify the any user interface image, and determining a set of operable elements in the any user interface image; and
obtain corresponding operation data and the post-operation user interface image by performing an operation on each operable element in the set of operable elements.

11. The electronic device according to claim 9, wherein when the instructions are executed by the at least one processor, the at least one processor is further caused to:
in a case that the state transition image comprises a cyclic path, determine a target task corresponding to the cyclic path;
determine a start user interface image and an end user interface image in the cyclic path based on the target task; and
obtain an acyclic state transition image corresponding to the target task by disconnecting a connecting edge between the start user interface image and the end user interface image.

12. The electronic device according to claim 9, wherein when the instructions are executed by the at least one processor, the at least one processor is caused to:
determine an operation object corresponding to the operation data based on operation data corresponding to each connecting edge in the state transition image;
obtain a marked user interface image by marking the operation object in the pre-operation user interface image corresponding to the operation data; and
obtain the trajectory image corresponding to the task by sequentially concatenating all marked user interface images corresponding to each task based on an operation sequence from front to back.

13. The electronic device according to claim 9, wherein when the instructions are executed by the at least one processor, the at least one processor is further caused to:
in a case that a number of nodes comprised in any branch in the state transition image is greater than a threshold, decompose a task corresponding to the any branch into a plurality of subtasks; and
decompose a state transition image corresponding to the any branch into a plurality of sub-state transition image branches based on the plurality of subtasks, wherein one sub-state transition image branch corresponds to one subtask.

14. The electronic device according to claim 13, wherein when the instructions are executed by the at least one processor, the at least one processor is further caused to:
determine a reference user interface image of each subtask;
in a case that a start user interface image corresponding to any subtask does not match the reference user interface image, determine a subtask in the state transition image, wherein the subtask corresponds to the end user interface image, matches the start user interface image of the any subtask and comprises a minimum number of nodes; and
obtain a complete state transition image of the any subtask by performing concatenation and completion on the state transition image corresponding to the any subtask, based on the state transition image corresponding to the one subtask.

15. The electronic device according to claim 13, wherein when the instructions are executed by the at least one processor, the at least one processor is caused to:
obtain a plurality of subtasks corresponding to the any branch, and a start user interface image and an end user interface image corresponding to each subtask output by a multimodal model, by inputting the trajectory image and the operation data sequence corresponding to the any branch into the multimodal model; or
determine a plurality of subtasks comprised in the task corresponding to the any branch based on a quantity of entities and/or operation data comprised in the task corresponding to the any branch.

16. The electronic device according to claim 9, wherein when the instructions are executed by the at least one processor, the at least one processor is further caused to:
determine a similarity between any two pieces of trajectory data based on the trajectory images in the pieces of trajectory data; and
in a case that the similarity between any two pieces of trajectory data is greater than a similarity threshold, delete one of the any two pieces of trajectory data from the plurality of pieces of trajectory data.

17. A non-transitory computer readable storage medium, storing computer instructions, wherein the computer instructions are configured to enable a computer to perform a method for generating training data, the method comprising:
obtaining interaction data with an application, wherein the interaction data comprises a plurality of pieces of operation data, a pre-operation user interface image corresponding to each piece of operation data, and a post-operation user interface image corresponding to each piece of operation data;
determining a state transition image based on the interaction data, wherein a node in the state transition image is the user interface image, and a connecting edge between every two user interface images is operation data associated with the two user interface images;
generating a plurality of pieces of trajectory data based on the state transition image, wherein each piece of trajectory data indicates a trajectory image and an operation data sequence corresponding to a task;
obtaining reasoning reference information corresponding to the operation data in the trajectory data output by the multimodal model, by inputting the trajectory data into a multimodal model, wherein the reasoning reference information describes a reasoning process for the operation data; and
generating training data for training an interaction agent model based on the trajectory data and the reasoning reference information corresponding to the operation data in the trajectory data.
